(19) United States
(12) Patent Application Publication
(10) Pub. No.: US 2026/0048792 A1
(43) Pub. Date: Feb. 19, 2026

(54) Front End for a Passenger Car

(71) Applicant: Bayerische Motoren Werke Aktiengesellschaft, Muenchen (DE)

(72) Inventors: Alicia BAUMANN, Muenchen (DE); Simone CHIRRA, Mering (DE); Christof SCHULZE, Muenchen (DE)

(21) Appl. No.: 19/101,960

(22) PCT Filed: Jun. 27, 2023
(86) PCT No.: PCT/EP2023/067369

§ 371 Date: Feb. 7, 2025

(30) Foreign Application Priority Data
Sep. 20, 2022 (DE) 10 2022 124 110.6

(51) Int. Cl. B62D 21/15; B62D 25/08; B62D 27/06

(52) U.S. Cl. CPC B62D 21/15; B62D 25/08; B62D 27/065

(57) ABSTRACT

A front end for a passenger car includes a first, upper side-member plane, which has first longitudinal side members mutually spaced in the vehicle transverse direction and a first crossmember, by which the first side members are connected to each other, and a second, lower side-member plane, which has second longitudinal side members mutually spaced in the vehicle transverse direction and a second crossmember, by which the second side members are connected to each other. A catch element is provided, which is connected to the crossmembers and by which at least one component of the front end provided in addition to the crossmembers, the side members and the catch element, is at least partially overlapped toward the rear in the vehicle longitudinal direction, whereby an accident-induced rearward displacement of the component can at least be limited.

### BACKGROUND AND SUMMARY

The invention relates to a front end for a passenger car having a first, upper longitudinal member plane which comprises first longitudinal members, which are spaced apart from each other in the transverse direction of the vehicle, and a first crossmember, via which the first longitudinal members are connected to each other, and having a second, lower longitudinal member plane which comprises second longitudinal members, which are spaced apart from each other in the transverse direction of the vehicle, and a second crossmember, via which the second longitudinal members are connected to each other,

A bumper for a motor vehicle, having a crossmember fixed on the vehicle, is known from DE 10 2006 030 504 A1. Furthermore, DE 10 2021 207 438 A1 discloses a front structure of a vehicle body. In addition, an energy absorption device for a bumper of a vehicle is known from WO 2020/200604 A1.

It is the object of the present invention to provide a front end for a passenger car such that a particularly advantageous accident behavior can be realized.

This object is achieved according to the invention by a front end having the features of the independent claim(s). Advantageous refinements of the invention are the subject matter of the dependent claims.

The invention relates to a front end for a passenger car, which is referred to simply also as a vehicle and is in the form of a motor vehicle. The front end has a first, upper longitudinal member plane which has first longitudinal members, which are spaced apart from each other in the transverse direction of the passenger car. The respective first longitudinal member extends at least substantially in the longitudinal direction of the passenger car. In other words, it is provided that a respective direction of longitudinal extent of the respective first longitudinal member runs in the longitudinal direction of the vehicle, consequently parallel to the longitudinal direction of the vehicle, which is also referred to as the x direction. The transverse direction of the vehicle runs perpendicularly to the longitudinal direction of the vehicle and is also referred to as the y direction. The respective first longitudinal member is elongate along its respective direction of longitudinal extent. The first longitudinal member plane is also referred to as a first member plane and has a first, upper crossmember, the direction of longitudinal extent of which runs perpendicularly to the respective direction of longitudinal extent of the respective first longitudinal member and thus runs at least in the transverse direction (y direction) of the vehicle. The first, upper longitudinal members are connected to each other via the first, upper crossmember, in particular in such a manner that the first, upper crossmember is attached, in particular at both ends, to the upper, first longitudinal members.

The front end also has a second, lower longitudinal member plane which is arranged below the upper longitudinal member plane in the vertical direction of the passenger car. The vertical direction of the vehicle is also referred to as the z direction. As viewed in the vertical direction of the passenger car, the second, lower longitudinal member plane can be the lowermost longitudinal member plane of the front end, in particular of the passenger car. As viewed in the vertical direction of the vehicle, the first, upper longitudinal member plane can be the uppermost longitudinal member plane of the front end, in particular of the passenger car, or can adjoin at least or precisely one additional longitudinal member plane upward in the vertical direction of the vehicle such that, for example, the upper, first longitudinal member plane, as viewed in the vertical direction of the vehicle, is arranged between the second longitudinal member plane and the additional longitudinal member plane and is therefore a or the central longitudinal member plane of the front end, in particular of the passenger car.

The second, lower longitudinal member plane has two second longitudinal members, the respective direction of longitudinal extent of which runs in the longitudinal direction of the vehicle, that is to say parallel to the longitudinal direction of the vehicle. The respective, second longitudinal member therefore extends at least in the longitudinal direction of the vehicle; consequently, the respective, second longitudinal member runs in elongate form along its respective direction of longitudinal extent.

The second, lower longitudinal members are spaced apart from each other in the transverse direction of the vehicle. The second, lower longitudinal member plane is also referred to as a second, lower member plane and comprises a second, lower crossmember, the direction of longitudinal extent of which runs perpendicularly to the respective direction of longitudinal extent of the respective, second longitudinal member, wherein the direction of longitudinal extent of the lower crossmember runs at least substantially in the transverse direction of the vehicle. The respective crossmember extends at least substantially in elongate form along its respective direction of longitudinal extent. The second, lower longitudinal members are connected to each other via the second, lower crossmember, in particular in such a manner that the second, lower crossmember is attached, in particular at both ends, that is to say at both of its ends, to the second, lower longitudinal members. For example, in the event of an accident, in particular in the event of a head-on collision or a head-on impact, of the passenger car, which is also referred to as a motor vehicle, a respective load path can form in the respective longitudinal member plane or via the respective longitudinal member plane, with accident-induced loads or forces being able to be absorbed and/or conducted via the respective load path. The load path forming in the or via the first longitudinal member plane is also referred to, for example, as a first load path, and the load path forming in the or via the second longitudinal member plane is also referred to, for example, as a second load path. In particular, accident-induced loads or forces which, for example in the event of a head-on collision or a head-on impact of the passenger car, act from the front to the rear in the longitudinal direction of the passenger car can be conducted or guided from the front to the rear in the longitudinal direction of the vehicle via the respective load path or along the respective load path and, in the process, in particular supported.

In order now to be able to realize a particularly advantageous accident behavior of the passenger car, in particular in situations, in particular accident situations, in which the passenger car impacts with its front, and therefore with its front end, against an accident barrier at just a low speed of, for example, less than 20 kilometers per hour, according to the invention a catch element is provided which is in particular formed separately from the longitudinal members and separately from the crossmembers and which is attached to the crossmembers, and thus to the first, upper crossmember and to the second, lower crossmember. By this means, the crossmembers are connected to each other via the catch element. This means in particular that, for example in the event of a head-on collision of the passenger car, the load paths forming during the head-on collision are connected to one another via the catch element, and therefore, for example, one of the longitudinal member planes can be supported on the other longitudinal member plane via the catch element and thus one of the load paths can be supported on the other load path via the catch element. By means of the catch element, at least one component of the front end, which component is provided in addition to the crossmembers, in addition to the longitudinal members and in addition to the catch element and in particular is formed separately from the crossmembers, separately from the longitudinal members and separately from the catch element, is at least partially overlapped to the rear in the longitudinal direction of the vehicle, as a result of which an accident-induced rearward displacement of the component can be limited, in particular in the event of the previously mentioned head-on collision. In other words, owing to the fact that the component is overlapped, and thus covered, by the catch element to the rear in the longitudinal direction of the vehicle, the component can be supported or is supported on the catch element to the rear in the longitudinal direction of the vehicle. This means in particular that the component, as viewed to the rear in the longitudinal direction of the vehicle, is in supporting contact with the catch element, or comes into supporting contact with the catch element as a result of an accident-induced rearward displacement of the component taking place to the rear in the longitudinal direction of the vehicle.

The supporting contact of the component with the catch element to the rear in the longitudinal direction of the vehicle and the described connection of the longitudinal member planes and of the load paths make it possible to avoid an excessive, accident-induced rearward displacement of the components to the rear in the longitudinal direction of the vehicle, and therefore, for example, an excessive intrusion of the component into passenger car regions arranged behind the component in the longitudinal direction of the vehicle can be avoided. As a result, for example, in the event of the previously mentioned head-on collision, in which the passenger car impacts with its front against an accident barrier, for example at just a low vehicle speed of less than 20 kilometers per hour, passenger car elements arranged in the regions mentioned can be kept free from damage, or excessive damage of elements arranged in the regions can be avoided, and therefore excessive repair work, in particular repair costs, resulting from the head-on collision can be avoided.

The catch element is particularly advantageously suitable whenever the elements arranged in the regions are at just a small distance running in the longitudinal direction of the vehicle from a part of an outer skin of the passenger car facing forward in the longitudinal direction of the vehicle. This is the case in particular whenever the passenger vehicle has an only small overhang on the front side. Only a small path, also referred to as a deformation path or crash path, may then be available to absorb accident energy in particular due to deformation of structural elements, for example energy absorption elements, and/or only a very slight accident-induced rearward displacement of the components to the rear in the longitudinal direction of the vehicle can be permitted without excessive damage of elements arranged in the regions occurring. It is now possible by means of the catch element to keep the distance mentioned particularly small, and thus to provide a particularly small overhang on the front side of the passenger car, with it being possible at the same time to avoid an excessive, accident-induced rearward displacement of the component. As a result, excessive damage of elements arranged in the regions as a consequence of a head-on impact or a head-on collision of the passenger car can be avoided.

The catch element is or forms a restraint system or is part of a restraint system, with it being possible, in respect of accident-induced damage, for sensitive elements to be protected from excessive damage by means of the restraint system by the fact that an excessive, accident-induced displacement of the component can be avoided. The restraint system, and thus the catch element, is distinguished in particular by the fact that the catch element, for example within what is referred to as an accident management system, forms, is or produces a connection between the first load path and the second load path. This connection makes it possible to ensure that components which are arranged in front of the catch element in the longitudinal direction of the vehicle and are in each case at least partially overlapped to the rear in the longitudinal direction of the vehicle by the catch element, for example the previously mentioned at least one component, are not rearwardly displaced excessively far to the rear in the event of a head-on collision or a head-on impact of the passenger car and thus do not penetrate excessively into the previously mentioned regions, and therefore elements arranged in the regions can be protected from excessive damage.

For example, the component is or comprises at least one air-guiding element, in particular for guiding cooling air to a radiator. Furthermore, it is contemplated for the component to be or to comprise a paneling and/or a decorative grille. Furthermore, the component can be or comprise a closing device which is arranged, for example, in an opening through which air can flow, also referred to as a cooling air opening, in particular in a front skirt, thus in a front paneling of the passenger car. The air is in particular cooling air which can be supplied, for example, to the previously mentioned radiator, which can be part of a cooling module comprising a plurality of radiators. The closing device can be switched over, for example, between a closed state and at least one open state. In the closed state, at least a partial region of the opening is blocked by means of the closing device, and therefore, for example during forward travel of the passenger car, air cannot flow through the blocked partial region of the opening. In the open state, the closing device, for example, opens up at least the partial region, and therefore, for example during forward travel of the passenger car, air can flow in particular as cooling air through the partial region of the opening and, in consequence, can be supplied, for example, to the radiator or can flow against and around the radiator. Thus, for example, the component is a flap or the component comprises at least one or more flaps. The respective flap is also referred to as an air flap. For example, the flap is movable, in particular pivotable, in particular relative to the front paneling, between at least one closed position bringing about the closed state and at least one open position bringing about the open state. In the closed position, the partial region of the opening is blocked by the flap. In the open position, the flap opens up the partial region of the opening.

The previously mentioned radiator can be, for example, one of the previously mentioned elements. Therefore, in the event of a head-on collision or in the event of a head-on impact of the passenger car, excessive damage of the radiator caused by an accident-induced rearward displacement of the component can be avoided by means of the catch element.

In order to be able to avoid an excessive accident-induced rearward displacement of the component in a particularly simple and effective manner by means of the catch element, provision is made, in one embodiment of the vehicle, for the component and the catch element to be fastened to the first crossmember by means of the same fastening element. In other words, at least one or more fastening elements common to the component and to the catch element is or are provided, wherein both the component and the catch element are fastened to the upper, first crossmember by means of the respective fastening element common to the catch element and the component.

It has been shown to be particularly advantageous here if the fastening element penetrates both a first passage opening in the component and a second passage opening in the catch element, in particular in the longitudinal direction of the vehicle. As a result, an excessive accident-induced rearward displacement of the at least one component can be effectively and efficiently avoided in a particularly simple manner.

A further embodiment is distinguished in that at least one first fastening region of the component, in particular as viewed in the longitudinal direction of the vehicle, is arranged between the first, upper crossmember and a second fastening region of the catch element, in particular in such a manner that, for example, the first fastening region, as viewed in the longitudinal direction of the vehicle, is clamped between the first, upper crossmember and the second fastening region of the catch element. By this means, the component can be particularly effectively and efficiently secured against an excessive accident-induced rearward displacement running to the rear in the longitudinal direction of the vehicle, and therefore a particularly good accident behavior can be provided.

It is contemplated for the component to be supported on the second, lower crossmember and otherwise not connected to the second, lower crossmember, and therefore, for example with the exception of the component being supported on the lower, second crossmember, a more extensive connection between the component and the second, lower crossmember is omitted.

In a further, particularly advantageous embodiment of the invention, it is provided that a length region of the fastening element, which is common to the component and to the catch element and penetrates the passage opening, protrudes from the second fastening region, in particular in the longitudinal direction of the vehicle, on a side of the second fastening region that faces away from the first fastening region, in particular in the longitudinal direction of the passenger car, and, for example, that faces to the rear in the longitudinal direction of the vehicle. In particular, the length region of the fastening element protrudes to the rear in the longitudinal direction of the vehicle from the second fastening region. The fastening element is also referred to as a first fastening element and is therefore, for example, a bolt. For example, the bolt protrudes to the rear in particular in the longitudinal direction of the vehicle from a main region of the first, upper crossmember.

A second fastening element which is in particular provided in addition to the first fastening element and is formed separately from the first fastening element is connected to the length region, as a result of which the second fastening element is clamped, in particular directly, against the second fastening region, in particular toward the front in the longitudinal direction of the vehicle. By this means, the second fastening region is clamped, in particular directly, against the first fastening region, in particular toward the front in the longitudinal direction of the vehicle, and, by this means, the first fastening region is clamped against the first crossmember, in particular toward the front in the longitudinal direction of the vehicle. As a result, a particularly advantageous connection of the component and also of the catch element to the upper crossmember can be realized, and therefore an excessive, accident-induced rearward displacement of the component can be avoided in a particularly simple and effective manner.

It has been shown to be particularly advantageous here if the length region has an external thread, and therefore, for example, the first fastening element is a screw bolt. An internal thread of the second fastening element, which is, for example, in the form of a nut, is screwed onto the external thread. The second fastening element is therefore screwed onto the first fastening element, that is to say onto the length region. By this means, the second fastening element is connected to the length region and is clamped against the second fastening region, in particular toward the front in the longitudinal direction of the vehicle. By this means, a particularly advantageous respective connection of the catch element and the component to the upper crossmember can be realized, and therefore an excessive, accident-induced rearward displacement of the component can be particularly readily avoided.

In order, for example by means of the catch element, to be able to particularly readily restrain the component in relation to an accident-induced rearward displacement taking place to the rear in the longitudinal direction of the vehicle, provision is made, in a further refinement of the invention, for the catch element to have a transverse part extending in the transverse direction of the vehicle and the direction of longitudinal extent of which thus runs at least substantially in the transverse direction of the vehicle, consequently parallel to the transverse direction of the vehicle (y direction). In particular, the transverse part extends in elongate form along its direction of longitudinal extent. For example, the transverse part forms the second fastening region, and therefore, for example, the transverse part is attached to the upper crossmember by means of the fastening element or by means of the first fastening element and the second fastening element.

It has been shown to be particularly advantageous here if the catch element has at least one tab which extends downward in the vertical direction of the vehicle away from the transverse part. It is contemplated for the tab and the transverse part to be formed integrally with each other, and thus to be formed from a single piece. Furthermore, it is contemplated for the tab and the transverse part to be formed separately from each other and to be connected to each other, in particular in an integrally bonded manner, in particular to be welded to each other. At least a partial region of the component is overlapped to the rear in the longitudinal direction of the vehicle by the tab, and therefore the component can be particularly readily restrained.

In order, for example, to be able to avoid excessive, accident-induced rotational movements of the component and therefore an excessive, accident-induced rearward displacement of the component, provision is made, in a further refinement of the invention, for the tab to have a cutout, for example in the form of a passage opening, in which a lug, also referred to as a catch lug, of the component protruding to the rear in the longitudinal direction of the vehicle from a main body of the component engages, in particular in the longitudinal direction of the vehicle.

Finally, it has been shown to be particularly advantageous if the transverse part is connected to the upper crossmember, wherein the catch element has a strut which extends continuously downward in the vertical direction of the vehicle away from the transverse part and toward the second crossmember and is connected to the second crossmember, in particular directly. It is contemplated for the previously mentioned lug to be spaced apart from the lower, second crossmember. By contrast, the strut extends continuously and therefore without interruption from the transverse part to the second, lower crossmember, as a result of which the load paths are particularly effectively connected to each other via the catch element.

For example, the strut, in particular a partial region of the strut, has a passage opening, by means of which the strut can be screwed, and thereby connected, to the lower crossmember. As a result, a particularly fixed connection between the load paths or between the crossmembers and therefore between the longitudinal member planes can be provided.

A passenger car which is referred to simply as a vehicle and has a front end according to the invention is disclosed. Advantages and advantageous refinements of the front end according to the invention should be considered to be advantages and advantageous refinements of the passenger car, and vice versa.

Further details of the invention emerge from the description below of a preferred exemplary embodiment with the associated drawings.

### BRIEF DESCRIPTION OF THE DRAWINGS

FIG. 1 shows part of a schematic and sectioned side view of a front end of a passenger car;

FIG. 2 shows a further schematic side view of the front end;

FIG. 3 shows part of a schematic perspective view of the front end;

FIG. 4 shows part of a further schematic perspective view of the front end;

FIG. 5 shows part of a further schematic perspective view of the front end;

FIG. 6 shows part of a further schematic and sectioned side view of the front end in the event of a head-on impact of the passenger car at a low speed;

FIG. 7 shows a further schematic perspective view of a catch element of the front end; and

FIG. 8 shows part of a schematic perspective rear view of the front end.

In the figures, identical or functionally identical elements are provided with the same reference signs.

### DETAILED DESCRIPTION OF THE DRAWINGS

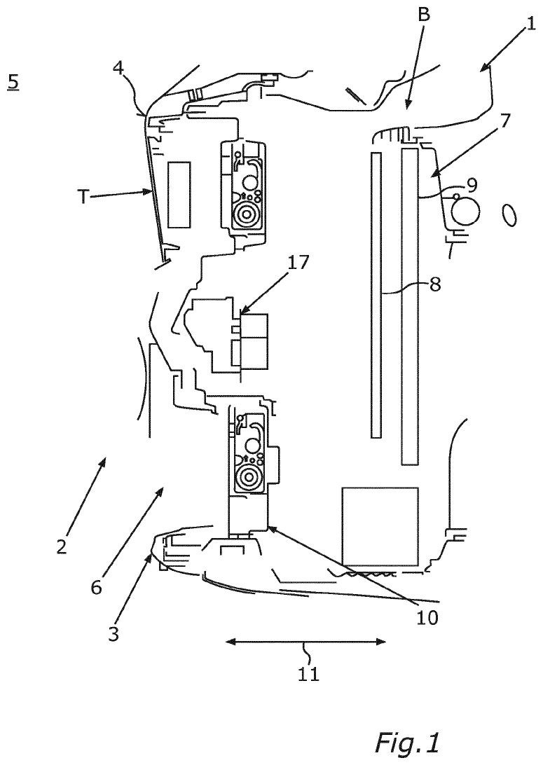

FIG. 1 shows part of a schematic and sectioned side view of a front end 1 of a passenger car, which is also referred to as a vehicle. This means that the passenger car in its completely manufactured state has the front end 1 which forms a or the front 2 of the passenger car. The front end 1 has a front paneling 3 by which a part T of an outer skin 4 of the passenger car is formed. The outer skin 4 is visually and haptically perceptible by people in an environment 5 of the passenger car and therefore of the front end 1, and therefore the people in the environment 5 can visually perceive, i.e., look at and haptically perceive, i.e., touch, the outer skin 4, in particular in a completely or ready manufactured state of the passenger car. For example, the front paneling 3 is or comprises a front-side and thus front bumper paneling.

The front paneling 3 has at least one opening 6 through which air can flow, in particular during forward travel of the passenger car, and which is in particular in the form of a passage opening and is also referred to as a cooling air opening.

The front end 1 and thus the passenger car also has a cooling module 7 which has at least one or here a plurality of radiators 8 and 9, here in the form of heat exchangers. The air flowing through the opening 6 can flow as cooling air to and around the radiators 8 and 9. A coolant, for example, can flow through the radiators 8 and 9. Via the respective radiator 8, 9, the respective coolant flowing through the respective radiator 8, 9 can be cooled by means of the cooling air flowing to and/or around the respective radiator 8, 9 in such a manner that heat can be transferred from the coolant flowing through the respective radiator 8, 9 via the respective radiator 8, 9 to the cooling air flowing to and around the respective radiator 8, 9.

The front end 1 has a component which is provided in addition to the cooling module 7 and which, in the exemplary embodiment shown in the figures, is in the form of a closing device 10 and is also referred to as an air flap or has at least one or more air flaps. The closing device 10 is arranged in the opening 6 and is adjustable between at least one open state and a closed state. In the closed state, at least a partial region of the opening 6 is blocked by means of the closing device 10, and therefore no air can flow through the partial region even during forward travel of the passenger car. In the open state, the closing device 10 opens up the partial region, and therefore, for example during forward travel of the passenger car, air can flow through the partial region of the opening 6. Thus, by means of the closing device 10, a quantity of air flowing through the opening 6 and flowing to and around the cooling module via the opening 6 can be varied. It can be seen that the cooling module 7 and therefore the radiators 8 and 9 are arranged behind the closing device 10 in the longitudinal direction of the passenger car, which is also referred to as a vehicle. The longitudinal direction of the vehicle is shown by a double arrow 11.

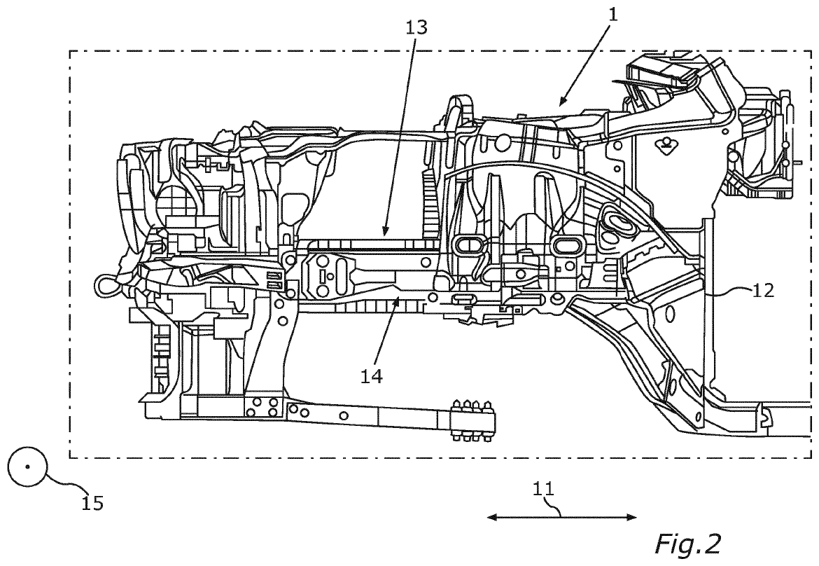

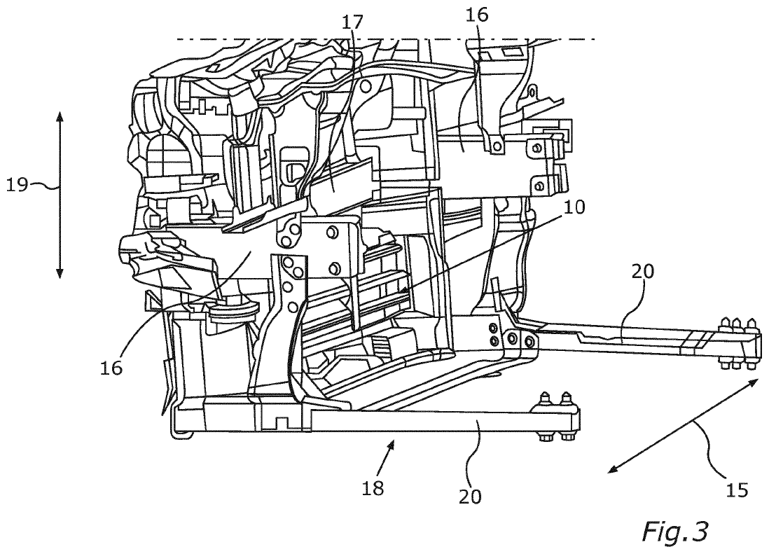

In combination with FIG. 2, it can be seen that the front end 1 has a partition 12 which is also referred to, for example, as a bulkhead or end wall and by which, for example, the passenger car interior, which is also referred to as a passenger cell or passenger compartment, is separated, as viewed in the longitudinal direction of the vehicle, from a region B which is arranged in front of the interior in the longitudinal direction of the vehicle and in which, for example, the cooling module 7 is arranged. In addition, the front end 1 has a first, upper longitudinal member plane 13 which has at least or precisely two first longitudinal members 14 which are spaced apart from each other in the transverse direction of the passenger car. The transverse direction of the vehicle runs perpendicularly to the longitudinal direction of the vehicle and is shown by a double arrow 15. It can be seen from FIG. 2 that the longitudinal direction of the vehicle runs perpendicularly to the plane of the image of FIG. 2. Energy absorption elements 16 which are constituent parts of the upper longitudinal member plane 13 adjoin the first, upper longitudinal members 14 toward the front in the longitudinal direction of the vehicle. The energy absorption elements 16 are formed separately from the longitudinal members 14 and are attached to the longitudinal members 14 such that a respective length region of the respective energy absorption element 16 adjoins the respectively associated, upper longitudinal member 14 toward the front in the longitudinal direction of the vehicle. The respective energy absorption element 16 is also referred to as a deformation element, deformation box, defobox or crash box. The first, upper longitudinal member plane 13 is a first member plane which comprises the first longitudinal members 14 and a first, upper crossmember 17 (FIG. 3). The longitudinal members 14 are connected to each other via the crossmember 17, here in such a manner that the crossmember 17 is attached to the energy absorption elements 16 and via the latter to the longitudinal members 14. The energy absorption elements 16 are thus connected to one another here by means of the crossmember 17.

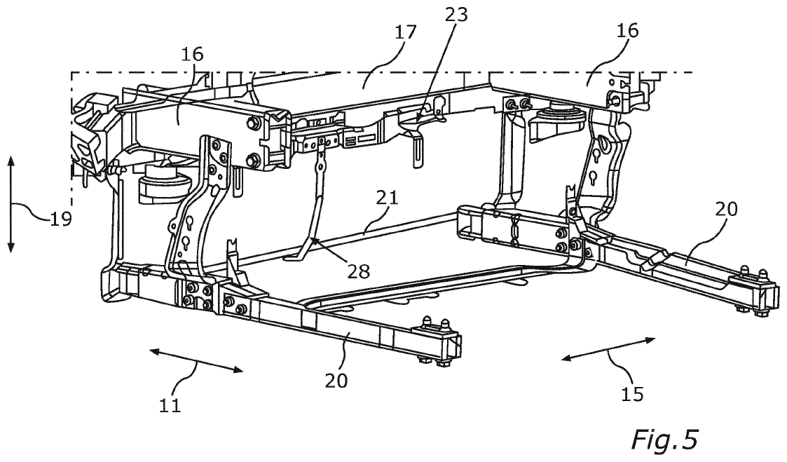

The front end 1 also has a second, lower longitudinal member plane 18 which is also referred to as a second member plane. The longitudinal member plane 18 is arranged below the upper, first longitudinal member plane 13 in the vertical direction of the passenger car, wherein the vertical direction of the vehicle is shown by a double arrow 19 and runs perpendicularly both to the longitudinal direction of the vehicle and to the transverse direction of the vehicle. It can be seen particularly readily from FIG. 3 that the second, lower longitudinal member plane 18 has at least or precisely two longitudinal members 20 which are spaced apart from each other in the transverse direction of the vehicle (double arrow 15). In addition, the second, lower longitudinal member plane 18 has at least or precisely one second, lower crossmember 21 which is illustrated particularly schematically in FIG. 5 and via which the second, lower longitudinal members 20 are connected to each other. The first, upper crossmember 17 can also be seen particularly readily from FIG. 1.

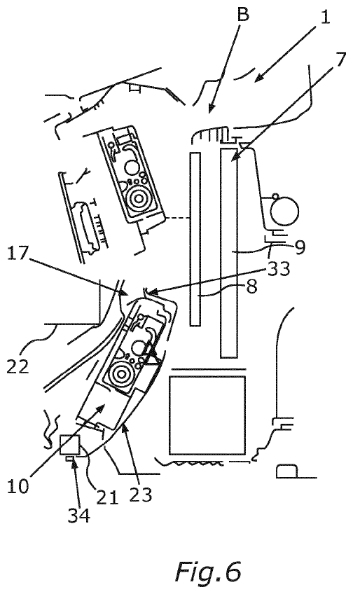

An accident barrier 22 can be partially seen in FIGS. 1 and 6, against which, for example, the passenger car in FIG. 6 impacts by means of its front 2, which is formed by the front end 1, specifically, for example, at a low speed which is, for example, less than 30 km/h, in particular less than 20 km/h, and is, for example, 15 km/h. It can be seen from FIG. 6 that, as a result of the fact that the front 2, and thus the front end 1, impacts against the accident barrier 22, an accident-induced rearward displacement of the closing device 10 (component) running from the front to the rear in the longitudinal direction of the vehicle occurs or may occur. This accident-induced rearward displacement of the closing device 10 runs to the rear in the longitudinal direction of the vehicle and in the direction of the region B, and thus in the direction of the cooling module 7 which is arranged in the region B. FIG. 6 thus shows a head-on collision which is also referred to as a head-on impact and in which the passenger car, as described, impacts against the accident barrier 22 at just the low speed.

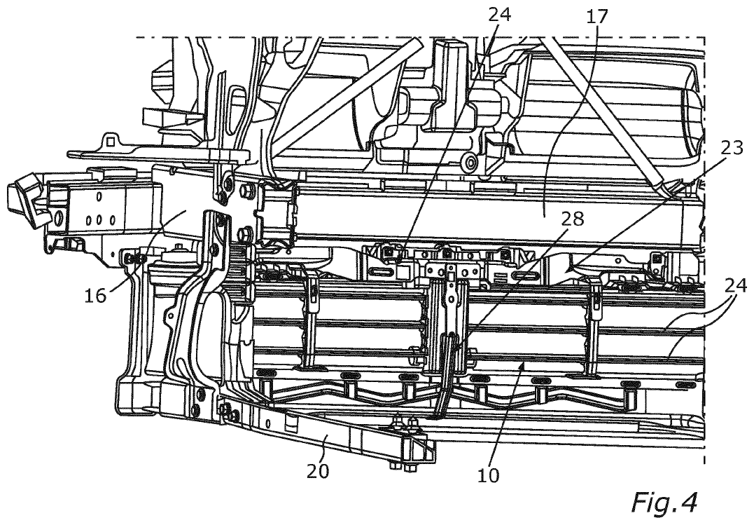

In order then to avoid an excessive rearward displacement of the closing device 10 resulting from the head-on collision and therefore excessive damage to the cooling module 7 resulting from the head-on collision and, in consequence, to be able to realize a particularly advantageous accident behavior of the passenger car, the front end 1 has a catch element 23 which can be seen particularly readily from FIGS. 4 to 8. The catch element 23 is formed separately from the longitudinal members 14 and 20 and separately from the crossmembers 17 and 21 and is provided both in addition to the longitudinal members 14 and 20 and in addition to the crossmembers 17 and 21. The catch element 23 is attached to the crossmembers 17 and 21, i.e. is connected to the crossmembers 17 and 21, as a result of which the crossmembers 17 and 21 and therefore the member planes mentioned are connected to one another via the catch element 23. The closing device 10, which can also be seen particularly readily from FIG. 8, is at least partially overlapped by the catch element 23 toward the rear in the longitudinal direction of the vehicle such that the closing device 10 is supported or can be supported on the catch element 23 toward the rear in the longitudinal direction of the vehicle. Thus, in the event of the described head-on collision, the closing device 10 is restrained by means of the catch element 23, i.e. secured against an excessive, accident-induced rearward displacement. As a result, excessive intrusion of the closing device 10 into the region B can be avoided, and therefore the closing device 10 cannot or not excessively damage the cooling module 7.

It can be seen from FIG. 8 that the closing device 10 has air flaps 35 which are movable, in particular pivotable, in particular relative to the crossmembers 17 and 21 and relative to the front paneling 3 between respective closed positions bringing about the closed state and respective open positions bringing about the open position.

The catch element 23 has a transverse part 24, the direction of longitudinal extent of which, along which the transverse part 24 extends in elongate form, runs in the transverse direction of the vehicle, i.e. parallel to the transverse direction of the vehicle. The transverse part 24 is fastened, in particular directly, to the upper crossmember 17, and therefore the catch element 23 is fastened to the crossmember 17 via the transverse part 24. For this purpose, for example, the transverse part 24 has screw openings which are in the form of passage openings 25 and are thread-free on the inner circumferential side. A corresponding first fastening element, which is designed here as a bolt, in particular as a screw bolt, protrudes from the crossmember 17 toward the rear in the longitudinal direction of the vehicle per passage opening 25. The screw bolts, which are provided on the crossmember 17, penetrate the passage openings 25. The closing device 10 likewise has passage openings, which are also referred to as second passage openings. The first fastening elements provided on the crossmember 17 penetrate the passage openings in the closing device 10 and the passage openings 25 in the transverse part 24, in particular in such a manner that the respective bolt protrudes from the respective passage opening 25 on a side S1 facing rearward in the longitudinal direction of the vehicle. The closing device 10 has a first fastening region, and the catch element 23, in particular the transverse part 24, has a second fastening region 26. The fastening region 26 has the passage openings 25 here, in particular in such a manner that the passage openings 25 penetrate the fastening region 26. The first fastening region of the closing device 10 is arranged between the crossmember 17 and the second fastening region 26 of the catch element 23 in the longitudinal direction of the vehicle. The first fastening region is clamped by means of the second fastening region 26, that is to say is clamped between the crossmember 17 and the fastening region 26, in particular as viewed in the longitudinal direction of the vehicle. Thus, the respective bolt protrudes from the fastening region 26 or from the transverse part 24 and therefore from the catch element 23 to the rear in the longitudinal direction of the vehicle on the side S1 facing rearward in the longitudinal direction of the vehicle and away from the first fastening region. The respective length region of the respective bolt has an external thread onto which a corresponding internal thread of a respective nut is screwed. The respective nut is a respective second fastening element. The nut is screwed onto the respective bolt in such a manner that the nut is clamped on the side S1 against the fastening region 26 and therefore against the transverse part 24. The second fastening region 26, and thus the transverse part 24 and the catch element 23, is thereby clamped against the first fastening region of the closing device 10, as a result of which the first fastening region of the closing device 10 is clamped against the crossmember 17, specifically in particular forward, in each case in the longitudinal direction of the vehicle. Thus, both the catch element 23 and the closing device 10 are fastened to the crossmember 17 by means of the same fastening elements, i.e. by means of the same bolts and by means of the same nuts. The transverse part 24 is formed, for example, integrally, i.e. is formed from a single piece.

The catch element 23 has a strut 27, the direction of longitudinal extent of which runs at least in the vertical direction of the vehicle, i.e. runs parallel to the vertical direction of the vehicle. The strut 27 extends in elongate form along its direction of longitudinal extent. The strut 27 is, for example, formed separately from the transverse part 24 and connected, in particular in an integrally bonded manner, in particular welded, to the transverse part 24. For example, the strut 27 is formed integrally, i.e. is formed from a single piece. The strut 27 extends continuously away downward in the vertical direction of the vehicle from the transverse part 24 and toward the second crossmember 21, the strut 27 being connected, in particular directly, to the lower, second crossmember 21. For this purpose, the strut 27 has a strut tab 28 which has a passage opening which is continuous, for example, in the vertical direction of the vehicle. For example, the passage opening in the strut tab 28 is penetrated by a third fastening element, in particular by a bolt and very particularly by a screw bolt, wherein a fourth fastening element, for example a nut, is connected to the third fastening element. The strut tab 28, for example, is clamped by means of the fourth fastening element against the crossmember 21 by the fact that the fourth fastening element is connected, in particular screwed, to the third fastening element, in particular in such a manner that the fourth fastening element is screwed onto the third fastening element. As a result, the strut 27 is screwed to the crossmember 21, and therefore the catch element 23 is connected to the lower, second crossmember 21.

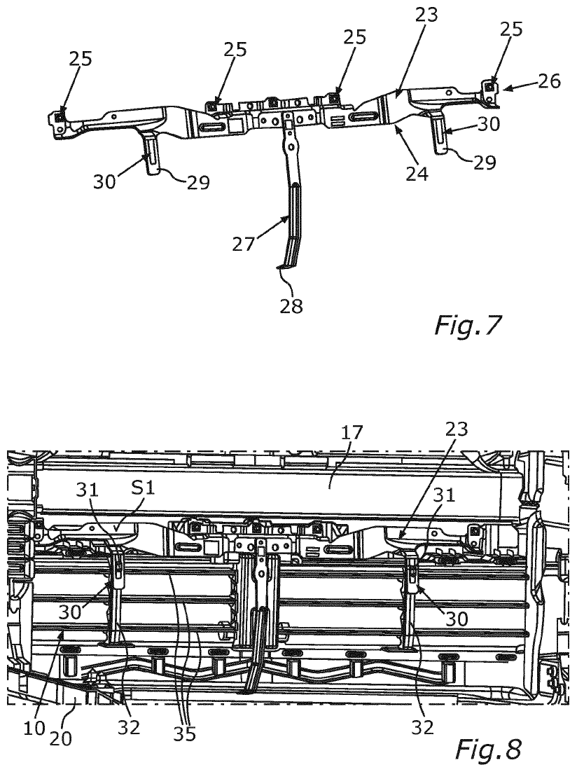

Furthermore, the catch element 23 has at least or precisely two tabs 29 which are spaced apart from each other in the direction of longitudinal extent of the transverse part 24 and therefore in the transverse direction of the vehicle. In particular, the strut 27 is arranged precisely in the center between the tabs 29, as viewed in the direction of longitudinal extent of the transverse part 24. The respective tab 29 protrudes downward from the transverse part 24 in the vertical direction of the vehicle, the respective tab 29, however, being spaced apart from the lower crossmember 21 in the vertical direction of the vehicle. It can be seen particularly readily from FIG. 7 that the respective tab 29 has a respective passage opening 30 which is continuous in the longitudinal direction of the vehicle. The respective passage opening 30 is a cutout. It can be seen from FIG. 8 that the closing device 10 has, in particular per passage opening 30, a respective lug 31 which protrudes toward the rear in the longitudinal direction of the vehicle from a main body 32 of the closing device 10. The respective lug 31 engages in the respective associated passage opening 30, here in such a manner that the respective passage opening 30 is penetrated by the respectively associated lug 31 in the longitudinal direction of the vehicle. By this means, for example, excessive rotational relative movements between the closing device 10 and the catch element 23, thus between the closing device 10 and the crossmembers 17 and 21, can be avoided, and therefore excessive intrusion of the closing device 10 into the region B can be avoided. For example, the catch element 23, in particular the transverse part 24 and the strut 27, is formed from a metallic material, in particular from steel. The catch element 23 as a whole is inherently stiff, consequently is dimensionally stable and is in the form of a solid body. In addition, the catch element 23 is not rubber-elastic here.

As can be seen from FIG. 6, an excessive, accident-induced rearward displacement of the closing device 10 can be avoided by means of the catch element 23, the attachment of which to the upper crossmember 17 is denoted by 33 in FIG. 6. As a result, the catch element 23, the lower attachment of which to the lower crossmember 21 is denoted by 34 in FIG. 6, acts as a restraint system, by means of which the closing device 10 can be restrained during the head-on collision mentioned and thus secured against an excessive rearward displacement taking place to the rear in the longitudinal direction of the vehicle. Excessive damage to the cooling module 7 can thereby be avoided. In particular, damage to the cooling module 7 as a whole can be avoided.

### LIST OF REFERENCE SIGNS

1 front end
2 front
3 front paneling
4 outer skin
5 environment
6 opening
7 cooling module
8 radiator
9 radiator
10 closing device
11 double arrow
12 end wall
13 first, upper longitudinal member plane
14 first longitudinal member
15 double arrow
16 energy absorption element
17 first, upper crossmember
18 second, lower longitudinal member plane
19 double arrow
20 second, lower longitudinal member
21 second, lower crossmember
22 accident barrier
23 catch element
24 transverse part
25 passage opening
26 first fastening region
27 strut
28 strut tab
29 tab
30 passage opening
31 lug
32 main body
33 attachment
34 attachment
35 air flap
B region
S1 side

1.-10. (canceled)

11. A front end for a passenger car, comprising:
a first, upper, longitudinal member plane which comprises first longitudinal members, which are spaced apart from each other in a transverse direction of the vehicle, and a first crossmember, via which the first longitudinal members are connected to each other;
a second, lower, longitudinal member plane which comprises second longitudinal members, which are spaced apart from each other in the transverse direction of the vehicle, and a second crossmember, via which the second longitudinal members are connected to each other; and
a catch element, which is attached to the first and second crossmembers and by which at least one component of the front end that is provided in addition to the first and second crossmembers, the first and second longitudinal members and the catch element, is at least partially overlapped to a rear in the longitudinal direction of the vehicle by the catch element, whereby an accident-induced rearward displacement of the component is at least limited by the catch element.

12. The front end according to claim 11, wherein
the component and the catch element are fastened to the first crossmember by way of a same fastening element.

13. The front end according to claim 12, wherein
the same fastening element penetrates a first passage opening in the component and a second passage opening in the catch element.

14. The front end according to claim 13, wherein
at least one first fastening region of the component is arranged between the first crossmember and a second fastening region of the catch element.

15. The front end according to claim 14, wherein
a length region of the fastening element protrudes from the second fastening region on a side of the second fastening region that faces away from the first fastening region,
a second fastening element is connected to the length region, as a result of which the second fastening element is clamped against the second fastening region, the second fastening region is clamped against the first fastening region, and the first fastening region is clamped against the first crossmember.

16. The front end according to claim 15, wherein
the length region has an external thread onto which an internal thread of the second fastening element is screwed, as a result of which the second fastening element is connected to the length region and is clamped against the second fastening region.

17. The front end according to claim 11, wherein
the catch element has a transverse portion extending in the transverse direction of the vehicle.

18. The front end according to claim 17, wherein
the catch element has at least one tab which extends downward in the vertical direction of the vehicle away from the transverse portion, and
at least a partial region of the component is overlapped to the rear in the longitudinal direction of the vehicle by the at least one tab.

19. The front end according to claim 18, wherein
the at least one tab has a cutout in which a lug of the component protruding to the rear in the longitudinal direction of the vehicle from a main body of the component engages.

20. The front end according to claim 17, wherein
the catch element, the transverse portion of which is connected to the first crossmember, has a strut which extends continuously downward in the vertical direction of the vehicle away from the first crossmember and toward the second crossmember and is connected to the second crossmember.
